(19) United States
(12) Patent Application Publication
(10) Pub. No.: US 2003/0016597 A1
(43) Pub. Date: Jan. 23, 2003

(54) Actuator apparatus for optical pickup having tilt control

(76) Inventors: Takashi Haruguchi, Fukuoka (JP); Junya Aso, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/196,409

(22) Filed: Jul. 17, 2002

(30) Foreign Application Priority Data
Jul. 18, 2001 (JP) 2001-218007
Sep. 18, 2001 (JP) 2001-283294
Sep. 21, 2001 (JP) 2001-288677

(51) Int. Cl. G11B 7/095

(52) U.S. Cl. 369/44.16; 369/244

(57) ABSTRACT

An actuator comprising: a moving portion including an objective lens, an objective lens holding cylinder, a focus coil, and a tracking coil; a first magnetic circuit for driving the focus coil; a second magnetic circuit for driving the tracking coil; and an elastic member for supporting the moving portion. The first magnetic circuit has a pair of focus coils and a pair of focus magnets disposed symmetrically about the objective lens and the second magnetic circuit has a pair of tracking coils and a pair of tracking magnets disposed symmetrically about the objective lens. Each of the pair of focus magnets in the first magnetic circuit and the pair of tracking magnets in the second magnetic circuit is constituted of divided magnets formed of a plurality of magnets joined together.

### FIELD OF THE INVENTION

The present invention relates to an optical pickup actuator (hereinafter referred to as “actuator”) to be mounted on an optical pickup for use in reproducing information from or recording information onto optical disks such as a high-density recording optical disk like DVD or a low-density optical disk like compact disk. Further, the invention relates to an optical disk apparatus using the optical pickup actuator of the invention.

### BACKGROUND OF THE INVENTION

Description will be given about a conventional optical pickup used in reproducing information from or recording information onto a high-density optical disk and a low-density optical disk, such as compact disk. FIG. 12 is a front view of a conventional optical pickup, FIG. 13 is a sectional view of the conventional optical pickup, FIG. 14 is a front view of a conventional actuator, and FIG. 15 is a sectional view of the conventional actuator.

The actuator for driving objective lens 55 in the conventional optical pickup will be described. In FIGS. 12-15, objective lens 55 is fixed to objective lens holding cylinder 59 with an adhesive or the like. Focus coil 62 for driving objective lens 55 in the focusing direction and tracking coil 63 for driving objective lens 55 in the tracking direction are fixed to objective lens holding cylinder 59 with an adhesive or the like.

By controlling values and directions of an electric currents passed through focus coil 62, and tracking coil 63, objective lens 55 follows the deviation of optical disk 1 in the focusing direction and tracking direction at all times.

Connecting terminals 64 for supplying power to focus coil 62 and tracking coil 63 also serve as members for holding objective lens holding cylinder 59 in the neutral position by means of suspension wires 65 and suspension holder 66. Suspension holder 66 is fixed to carriage 67 by adhesion or by soldering.

Carriage 67 moves between the inner periphery and the outer periphery of optical disk 1, over support shaft 68 and guide shaft 69.

Recently, the technology for speedups of reading and writing on optical disk 1 has been developed and higher recording density from compact disks to DVDs has been in progress. In the conventional optical pickups, the actuator is only capable of two axis control in the focusing direction and the tracking direction. Therefore, under the present circumstances where the technology for speedups and the higher density have been developed, such problems as warpage of the optical disk cannot be coped with by the conventional art and it has been a problem that recording and reproduction are difficult on such a disk.

Of optical pickups of a half height type (thickness being approximately 45 mm), actuators capable of performing tilt control in the radial direction have been developed and mass production of them have been advanced. However, those developed are not of such a thickness that is mountable on a notebook PC. Hence, there are strong demands for actuators usable for high-density optical disks, capable of making tilt control in the radial direction, and being very thin, small, and highly accurate.

Generally, when tilt control in the radial direction is performed in an actuator of a moving coil (MC) type for use in optical disks having a very narrow tilt margin such as high-density optical disks, a linearity of MC-type actuators is impaired by a radial tilt created by a lens shift.

In order to perform tilt control for such optical disks at high accuracy, it becomes essential to cope with the radial tilt occurring when the lens shift is made.

An example of the arts to cope with the radial tilt is disclosed in Japanese Patent Non-examined Publication No. H9-231595. According to the Publication, there is/are disposed one square coil/two square coils on one/two sides of an objective lens holder. Bundles of the opposite sides of the square coil are arranged to face opposite magnetic poles, so that driving forces in the opposite direction are applied to both sides of the lens holder. Thus, the lens is tilted. In this conventional art, however, the coil and the magnet only for the tilt control are required and this presents a problem of an increase in weight.

It is an object of the present invention to provide an actuator capable of tilt control in a radial direction and of three-axis control, capable of minimizing deterioration in the magnetic circuit characteristic when a coil shift is made, being very thin, small, and accurate, and having high linearity in controlling characteristics. It is another object of the present invention to provide an optical disk apparatus capable, through the use of the actuator of the present invention, of being mounted on a thin notebook PC and yet having a highly accurate controlling characteristic and being highly reliable at a recording and a reproduction.

### SUMMARY OF THE INVENTION

An actuator of the present invention comprises: a moving portion made up of an objective lens, an objective lens holding cylinder, a focus coil, and a tracking coil; a first magnetic circuit made up of a focus magnet for driving the focus coil and a magnetic yoke; a second magnetic circuit made up of a tracking magnet for driving the tracking coil and the magnetic yoke; and an elastic member for supporting the moving portion, in which the first magnetic circuit has a pair of focus coils and a pair of focus magnets disposed substantially symmetrically about the objective lens, and the second magnetic circuit has a pair of tracking coils and a pair of tracking magnets disposed substantially symmetrically about the objective lens. Each of the pair of focus magnets and the pair of tracking magnets is formed of divided magnets provided by combining a plurality of magnets together.

By a use of the configuration of the present invention, the actuator is enabled to make tilt control in the radial direction and capable of making three-axis control. Therefore, degradation of the magnetic circuit characteristic due to a coil shift can be minimized. Thus, an actuator being very thin, very small, and highly accurate and having high linearity in controlling characteristic can be obtained.

Further, with the use of the actuator of the invention, an optical disk apparatus capable of being mounted on a thin notebook PC and yet having a highly accurate controlling characteristic and being highly reliable in the performance of recording and reproduction can be provided.

### BRIEF DESCRIPTION OF THE DRAWINGS

FIG. 1 is a front view of an optical pickup module (hereinafter called “module”) having an actuator of a first preferred embodiment of the invention mounted thereon.

FIG. 2 is a detailed front view of the module shown in FIG. 1.

FIG. 3 is a sectional view of the module shown in FIG. 1.

FIG. 4 is an enlarged front view of the actuator of the first preferred embodiment of the invention.

FIG. 5 is a sectional view taken along the line V-V of FIG. 4.

FIG. 6A is a sectional view taken along a line W-W of the actuator device portion shown in FIG. 4 showing a state having not yet made a lens shift in the tracking direction.

FIG. 6B is a partially enlarged view of FIG. 4.

FIG. 6C is a sectional view taken along a line Y-Y of the actuator device portion shown in FIG. 4 showing a state having not yet made a lens shift in the tracking direction.

FIG. 7A is a sectional view taken along a line W-W of the actuator device portion shown in FIG. 4 showing a state having made a lens shift toward a disk inner periphery.

FIG. 7B is an partially enlarged view of the actuator device portion shown in FIG. 4 showing a state having made a lens shift toward the disk inner periphery.

FIG. 7C is a sectional view taken along a line Y-Y of the actuator device portion shown in FIG. 4 showing a state having made a lens shift toward the disk inner periphery.

FIG. 8A is a sectional view taken along a line W-W of the actuator device portion shown in FIG. 4 showing a state having made a lens shift toward the disk outer periphery.

FIG. 8B is a partially enlarged view of the actuator device portion shown in FIG. 4 showing a state having made a lens shift toward the disk outer periphery.

FIG. 8C is a sectional view taken along a line Y-Y of the actuator device portion shown in FIG. 4 showing a state having made a lens shift toward the disk outer periphery.

FIG. 9A is a perspective view showing driving directions in focusing and tracking operations in the actuator device portion of the present invention.

FIG. 9B is a perspective view showing driving directions in focusing and tracking operations in the actuator device portion of the present invention.

FIG. 10A is a perspective view showing driving direction creating a tilt in the actuator device portion of the present invention.

FIG. 10B is a perspective view showing driving direction creating a tilt in the actuator device portion of the present invention.

FIG. 11 is a sectional view taken along the line Z-Z of FIG. 4.

FIG. 12 is a front view of a conventional optical pickup.

FIG. 13 is sectional view of the conventional optical pickup.

FIG. 14 is a front view of a conventional actuator.

FIG. 15 is a sectional view of the conventional actuator.

### DESCRIPTION OF THE PREFERRED EMBODIMENTS

The actuator of the present invention comprises: a moving portion made up of an objective lens, an objective lens holding cylinder for holding the objective lens, a focus coil for driving the objective lens in the focusing direction, and a tracking coil for driving the lens in the tracking direction; focus magnets and tracking magnets facing with focus coils and tracking coils, respectively; a magnetic yoke for holding a suspension holder, the suspension holder having the focus magnets and the tracking magnets provided thereon; and an elastic member fixed to the suspension holder for supporting the moving portion. The actuator of the present invention is characterized by that only a pair of the focus coils is disposed in a first magnetic circuit formed of the focus magnets and the magnetic yoke and only a pair of the tracking coils is disposed in a second magnetic circuit formed of the tracking magnets and the magnetic yoke, while the first magnetic circuit and the second magnetic circuit are disposed around the objective lens.

According to the configuration of the present invention, both controlling in the focusing direction and controlling in the tracking direction can be operated independently of each other. Further, it is made possible to perform tilt control in the radial direction by reversing a direction of electric currents passed through the pair of the focus coils disposed symmetrically about the objective lens.

The actuator of the present invention has two focus magnets disposed on the magnetic yoke to provide a pair of the first magnetic circuits. Further, each of the pair of the first magnetic circuits have a focus coil and the pair of the first magnetic circuits are disposed substantially symmetrically about the objective lens. Since symmetrical forces are applied to the objective lens, focusing operation can be stably performed, and even if focusing control is performed while tracking control is being performed, the focusing control can be performed independently of the tracking control, and tilt control can be performed.

The actuator of the present invention has two tracking magnets disposed on the magnetic yoke to provide a pair of second magnetic circuits. Further, each of the pair of the second magnetic circuits have a tracking coil and the pair of the second magnetic circuits are disposed substantially symmetrically about the objective lens.

The actuator of the present invention is characterized in that a width of the focus magnet in the tracking direction is smaller than that of the focus coil. When a tracking operation is made, a static tilt in the radial direction is generated by occurrence of a deviation between the centers of the focus magnet and the focus coil. This condition creates a magnetic imbalance so that a difference in the force in the focusing direction can be produced depending on a position at which the focus magnet is situated.

In the actuator of the present invention, a position of the focus magnet in the first magnetic circuit on an inner side of the disk is shifted toward the inner side with respect to the center of the focus coil, while a position of the focus magnet in the first magnetic circuit on an periphery side of the disk is shifted toward the periphery side with respect to the center of the focus coil. According to this configuration, when a deviation is produced between the center positions of the focus magnet and the focus coil while a tracking operation is made, if the deviation is such that is shifted toward the inner side of the disk, the magnetic force generated in the first magnetic circuit on the periphery side becomes smaller than the magnetic force generated in the first magnetic circuit on the inner side. And, if, on the other hand, the deviation is such that is shifted toward the periphery of the disk, the magnetic force generated in the first magnetic circuit on the inner side becomes smaller than the magnetic force generated in the first magnetic circuit on the outer periphery side. Thus, magnetic forces to cancel a tilt due to the tracking and focus control can be generated so that a linearity in the control characteristic can be enhanced and highly accurate tilt control becomes possible.

In the actuator of the present invention, each of the focus magnet and the tracking magnet is composed of a plurality of divided magnets bonded together. In a case where conventional multi-polar-magnetized magnets are used, neutral zones are produced between the poles. However, in the case of the present actuator where the magnet is provided by a plurality of magnets bonded together, no neutral zones are produced and, hence, the linearity in the control characteristic is enhanced.

The actuator of the present invention is characterized in that the magnetic yoke is formed in a U-shape, end portions of the magnetic yoke are disposed on both sides of the position where the objective lens is fixed in the objective lens holding cylinder. And the first and second magnetic circuits are disposed on each of the end portions independently of each other. Due to this configuration, where the first magnetic circuit and the second magnetic circuit are disposed on each end portion of the magnetic yoke and, hence, magnetic circuits can be distributed substantially symmetrically about the objective lens. Thus, a compact, thin, and small actuator can be obtained.

According to an optical pickup with the use of the actuator apparatus according to the present invention, the controlling accuracy can be improved and, therefore, it becomes possible to achieve accurate and highly reliable reproduction and recording operation. Further, according to an optical pickup with the use of the actuator apparatus of the present invention that has been made small in size and light in weight, it becomes possible to provide an optical pickup being small sized, consuming low energy, and yet being accurate and highly reliable.

Further, according to an optical pickup with the use of the actuator apparatus according to the present invention and an optical disk apparatus employing the optical pickup, accurate and highly reliable reproduction or recording operation can be performed. Further, an optical disk apparatus being thin, small, consuming low energy and highly reliable and mountable on such a computer as a mobile computer can be provided.

Description will be given in the following about a concrete embodiment with reference to the accompanying drawings.

First Preferred Embodiment

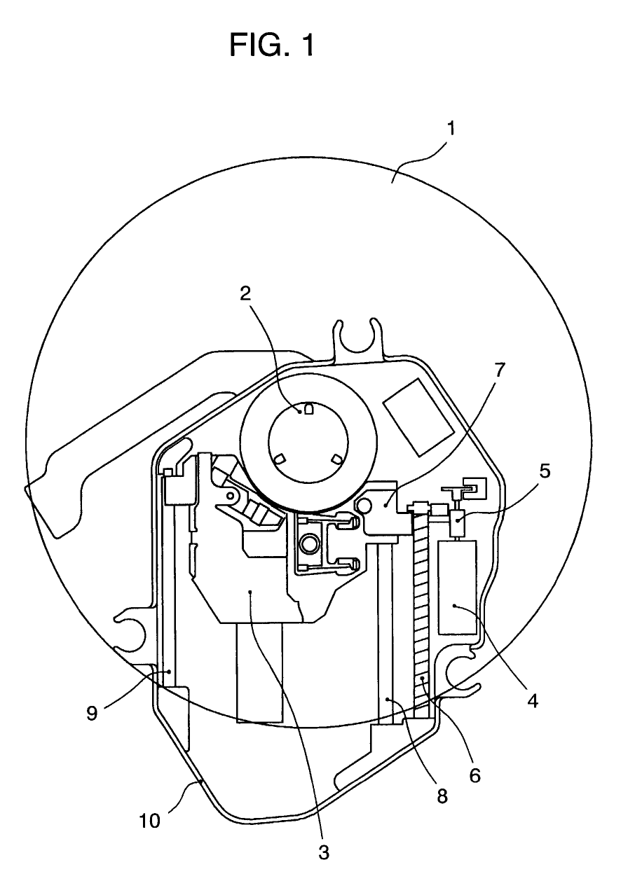

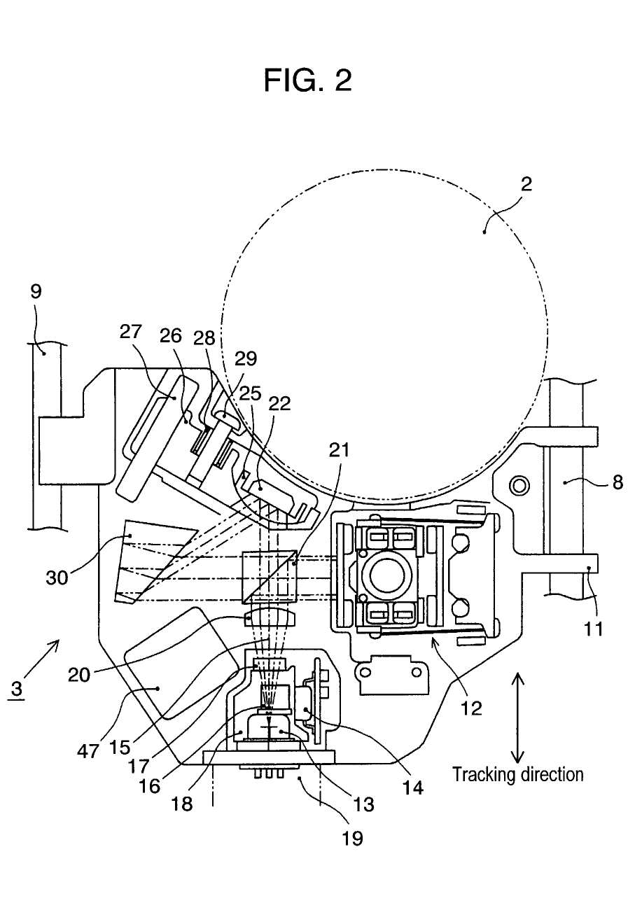

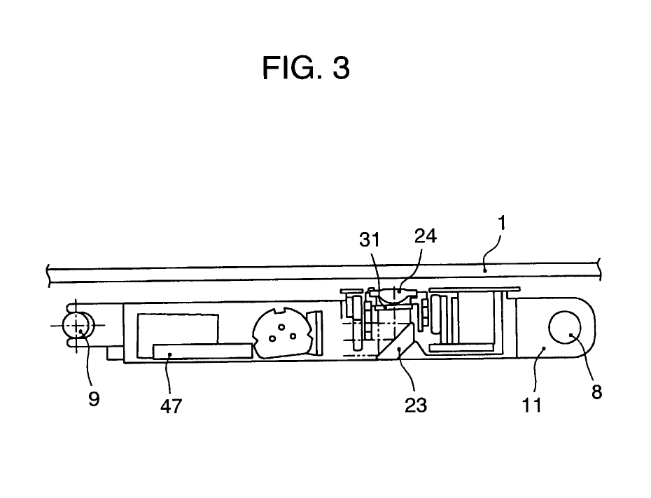

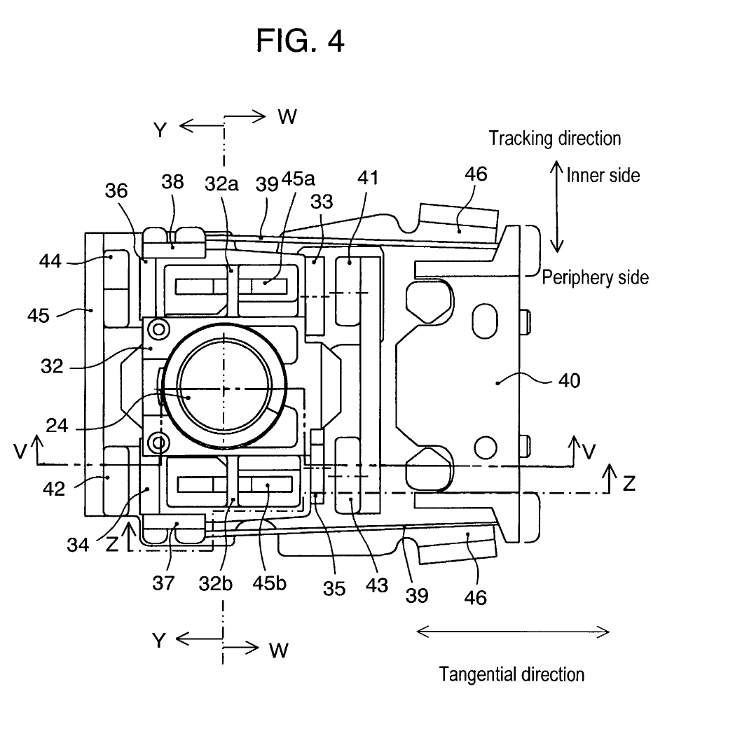

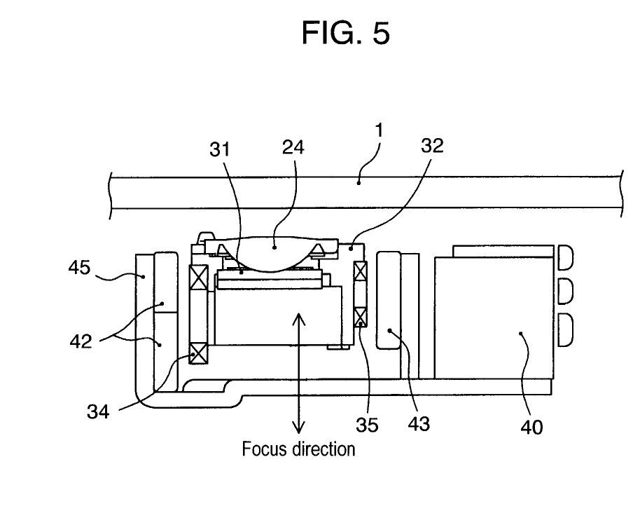

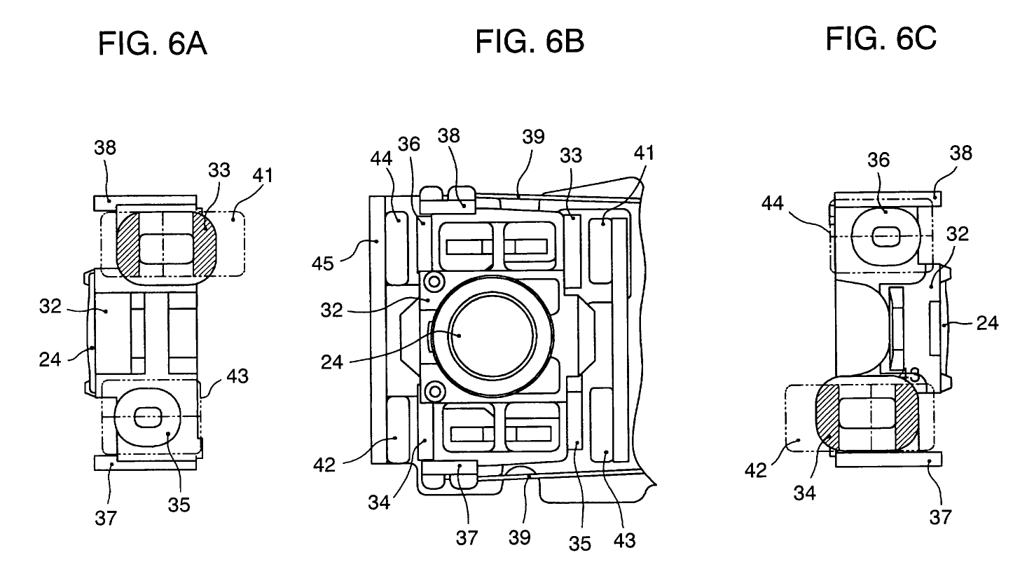

FIG. 1 is a front view of a module having an actuator according to a first preferred embodiment of the present invention mounted thereon. FIG. 2 is a detailed front view of the module shown in FIG. 1. FIG. 3 is a sectional view of the module shown in FIG. 1. FIG. 4 is an enlarged front view of the actuator in the first preferred embodiment of the invention and FIG. 5 is a sectional view taken along the line V-V of FIG. 4. FIGS. 6A-6C illustrate the actuator shown in FIG. 4 showing a state not yet made a lens shift in the tracking direction. FIG. 6A is a sectional view taken along a line W-W of the device and seen from the direction shown by the arrows, FIG. 6B is a partially enlarged view of the device, and FIG. 6C is a sectional view taken along a line Y-Y of the device and seen from the direction shown by the arrows.

In FIG. 1, optical disk 1 storing digital data is rotated by spindle motor 2. Incidentally, optical disk 1 is shown by a solid line in FIG. 1. Spindle motor 2 is provided with a chucking portion for holding optical disk 1. Optical pickup 3 reads digital data from optical disk 1 for reproduction or records digital data onto optical disk 1.

Optical pickup 3 moves between the inner side and a periphery of optical disk 1 by means of traverse motor 4, reduction gear 5, screw shaft 6, rack 7, support shaft 8, and guide shaft 9. Screw shaft 6 is provided with a spiral groove with which teeth of rack 7 fixed to optical pickup 3 engage and traverse motor 4 transmits a turning force to screw shaft 6 through reduction gear 5.

Support shaft 8 and guide shaft 9 slidably support optical pickup 3. The turning force of screw shaft 6, through rack 7, moves optical pickup 3. Normal or reverse rotation of traverse motor 4 moves optical pickup 3 reciprocally between the inner side and the periphery of optical disk 1. Spindle motor 2, traverse motor 4, optical pickup 3, and the like are mounted on optical pickup module base 10.

With reference to FIG. 2 and FIG. 3, carriage 11 placed on support shaft 8 and guide shaft 9 mounts actuator device 12 and optical system thereon.

Laser section 13 emits laser beams 15 of two wavelengths, i.e., a wavelength of 780 nm and a wavelength of 635-650 nm. Photo detector device 14 receives an optical signal from optical disk 1 and it is also provided with an optical monitor for monitoring an output of laser beam 15. Prism 16 as light splitting means transmits laser beam 15 and, at the same time, leads reflected light into photo detector device 14. Prism 16 is provided with a diffraction grating (not shown) for monitoring laser beam 15 and further provided with a diffraction grating (not shown) for splitting the beam of a wavelength of 780 nm at a position led to photo detector device 14. Further, on a side of prism 16 facing to laser section 13, a diffraction grating for forming three beams is formed and is used to avoid one laser wavelength being affected by another wavelength.

Diffraction grating 17 for dividing light of wavelength of 635-650 nm is made substantially immune to laser beam 15 of another wavelength. Bonding member 18 is a member for keeping laser section 13 and photo detector device 14 in place. A flexible circuit board (not shown) is mounted on photo detector device 14 and bonded to flexible circuit board 19 with a solder or the like. Collimator lens 20 collimates diverging light rays emitted from laser section 13 into substantially parallel rays. Beam splitter 21 splits and combines laser beam 15 of a wavelength of 780 nm and a wavelength of 635-650 nm.

As shown in FIG. 2, laser beam 15 of a wavelength of 780 nm is reflected by beam splitter 21 and laser beam 15 of a wavelength of 635-650 nm is transmitted therethrough. Reflecting mirror 22 reflects the wavelength of 635-650 nm laser beam transmitted through beam splitter 21.

Referring to FIG. 3, mirror 23 is made adjustable for the angle of reflection to the objective lens 24 and for its position. Mirror 22 is fixed by an adhesive to optical-axis adjusting member 25, which has a spherical surface or the like so as to be rotated with respect to shift member 26 for making the optical-axis adjustment.

Shift member 26 is fitted over slide shaft 27 and can be slide on carriage 11. Shift adjusting screw 29 is inserted in a through hole made in carriage 11 and then engaged with a female screw provided in shift member 26. By turning shift adjusting screw 29, shift member 26 can be slide on carriage 11.

At this time, shift spring 28 disposed between shift member 26 and carriage 11 hold these two members in elastic engagement with each other. Further, the contacting face between shift adjusting screw 29 and carriage 11 is formed in a taper shape to absorb a clearance between slide shaft 27 and shift member 26. Beam forming prism 30 forms laser beam 15 of a wavelength of 635-650 nm into a radial direction.

In FIG. 5, aperture filter 31 has a wavelength selecting function for determining a different numerical aperture for a different wavelength of laser beam 15 and a function of a λ/4 plate for converting linear polarization of laser beam 15 into circular polarization, and vice versa. Objective lens 24 is fixed to objective lens holding cylinder 32 with an adhesive or the like.

In FIGS. 6A and 6C, each of focus coils 33 and 34 is wound in a ring shape and tracking coils 35 and 36 are also wound in a ring shape. These focus coils 33, 34, tracking coils 35, and 36 are fixed to objective lens holding cylinder 32 with an adhesive or the like. Substrates 37 and 38 receive, as connecting terminals, power supply from conductive suspension wires 39 (“elastic members” in the present preferred embodiment) and also serve as substrates to which objective lens holding cylinder 32 is bonded.

One ends of suspension wires 39 are bonded to substrate 37 and substrate 38 with a solder or the like, while focus coils 33, 34 and tracking coils 35, 36 are also fixed to suspension wires 39 by soldering or the like. A flexible circuit board, for fixing another ends of suspension wires 39 by soldering or the like, is adhered to suspension holder 40

Further, substrate 37 and substrate 38 are fixed to objective lens holding cylinder 32 with an adhesive or the like. Suspension wires 39 comprise at least six round wires or leaf springs so as to be able to supply power to each of focus coils 33 and 34 and serially connected tracking coils 35 and 36.

Focus magnets 41 and 42 are formed to have width thereof in the tracking direction smaller than these of focus coils 33 and 34. Further, the centers of each of focus magnets 41, 42 are disposed to be shifted from the centers of each of focus coils 33, 34 as shown in FIG. 4. Namely, focus magnet 41 is shifted toward the inner side of the disk with respect to focus coil 33 and focus magnet 42 is shifted toward the periphery side of the disk with respect to the focus coil 34.

Focus magnets 41, 42 are disposed facing to focus coils 33, 34. On the other hand, tracking magnets 43, 44 are disposed facing to tracking coils 35, 36. More specifically, with reference to FIG. 4 and FIGS. 6A-6C, the winding surfaces formed by winding focus coils 33, 34 are substantially parallel to the focusing direction and the tracking direction and the axis of winding (the vertical line to the winding surface) is substantially orthogonal to the focusing direction and substantially parallel to the tangential direction. Further, a first focusing magnetic circuit comprising focus coil 33 and focus magnet 41 and a second focusing magnetic circuit comprising focus coil 34 and focus magnet 42 are disposed symmetrically about the center of objective lens 24.

Likewise, the winding surfaces formed by winding tracking coils 35, 36 are substantially parallel to the focusing direction and tracking direction and the axis of winding (the vertical line to the winding surface) is substantially orthogonal to the focusing direction and substantially parallel to the tangential direction. Further, a first tracking magnetic circuit comprising tracking coil 35 and tracking magnet 43 and a second tracking magnetic circuit comprising focus coil 36 and tracking magnet 44 are disposed symmetrically about the center of objective lens 24.

By the above described symmetrical arrangement of the first focusing magnetic circuit and the second focusing magnetic circuit around the center of the objective lens and symmetrical arrangement of the first tracking magnetic circuit and the second tracking magnetic circuit around the center of the objective lens, the center of electromagnetic driving forces coincide with the center of objective lens 24. Accordingly, accurate focus control and tracking control can be obtained.

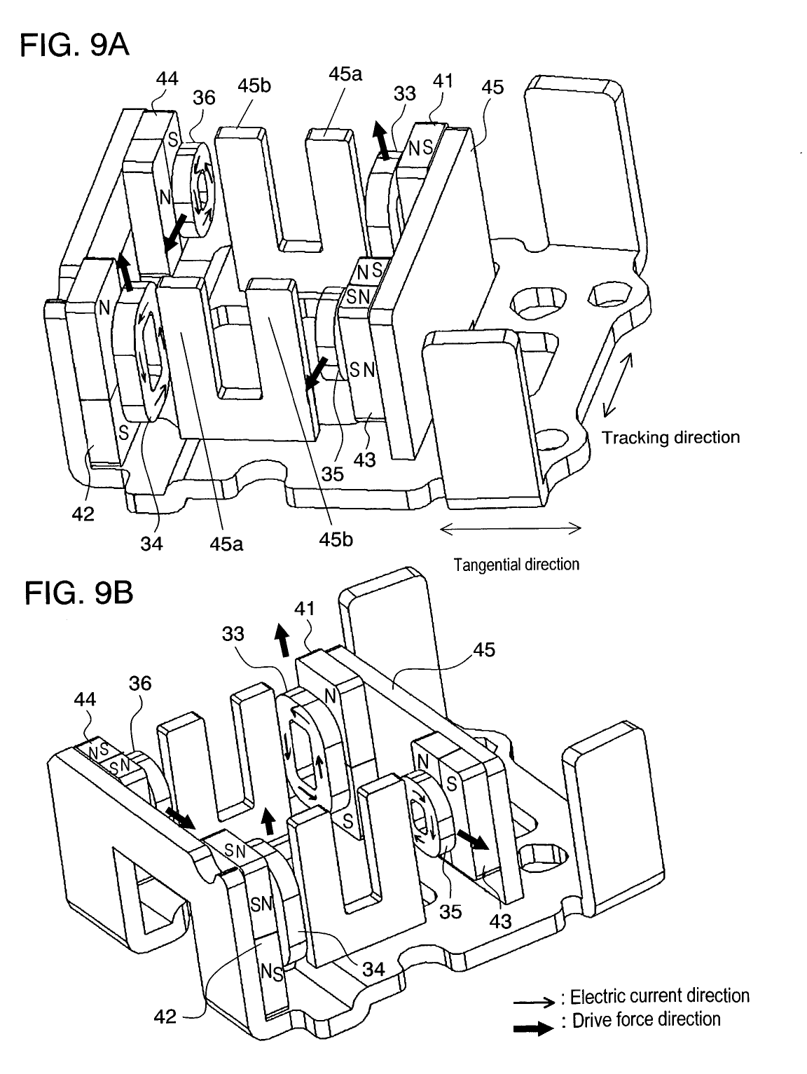

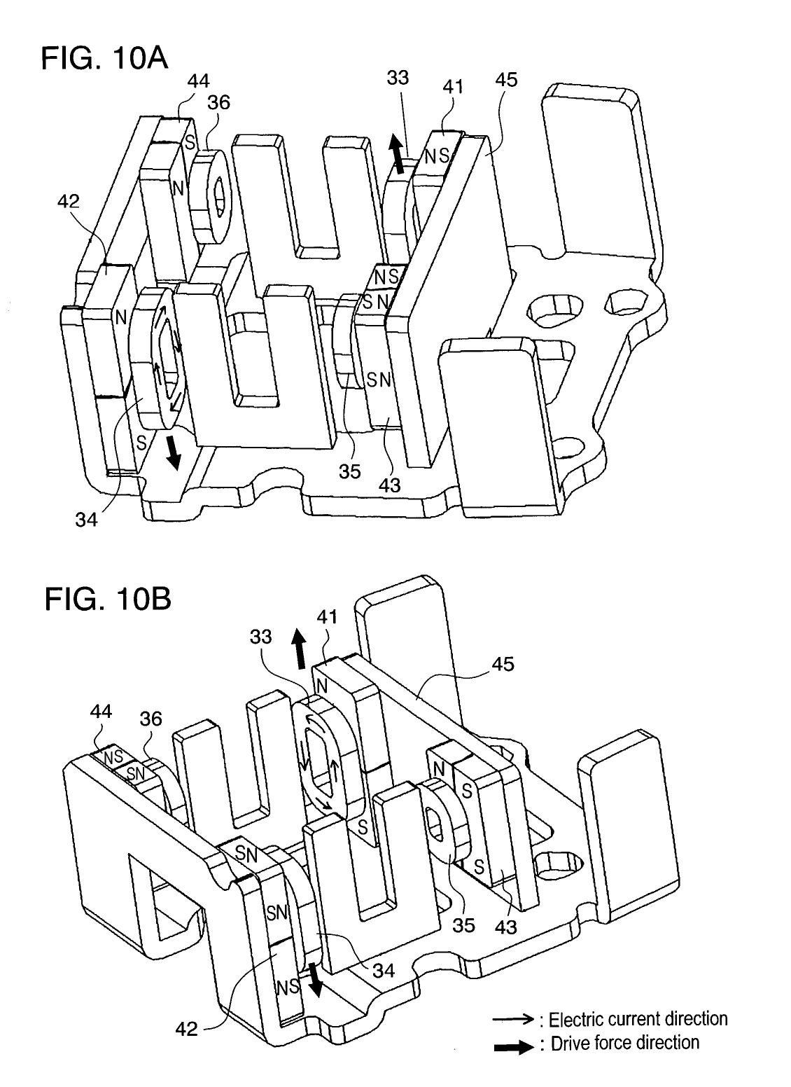

FIGS. 9A and 9B show a focusing and a tracking driving directions in the actuator apparatus portion of the present invention, of which FIG. 9A and FIG. 9B are perspective views seen from different angles. FIGS. 10A and 10B show driving directions of a tilt in the actuator apparatus portion of the present invention, of which FIG. 10A and FIG. 10B are perspective views seen from different angles. In the present preferred embodiment, as shown in FIG. 9A and FIG. 9B, each of focus magnets 41, 42 divided into two magnets in the focusing direction and one of the magnets is disposed with its pole magnetized reverse to a pole of another magnet. And tracking magnets 43, 44 are also divided into two magnets in the tracking direction and one of the magnets is disposed with its pole magnetized reverse to a pole of another magnet.

Further, as illustrated with polarities of N and S in FIG. 9A and FIG. 9B, the magnetic poles of magnets 41, 42 facing to a bundle of one side of focus coils 33, 34 are reverse to the magnetic poles of magnets 41, 42 facing to a bundle of another side of focus coils 33, 34.

Likewise, the magnetic poles of magnets 43, 44 facing to a bundle on one side of tracking coils 35, 36 are reverse to the magnetic poles of magnets 43, 44 facing to a bundle of another side of tracking coils 35, 36.

At this time, focus magnets 41, 42 and magnetic yoke 45 constitute a focus magnetic circuit (“first magnetic circuit” of the present invention) and tracking magnets 43, 44 and magnetic yoke 45 constitute a tracking magnetic circuit (“second magnetic circuit” of the present invention). Thus, such a configuration of the focus magnetic circuit including only a pair of focus coils 33, 34 and a configuration of the tracking magnetic circuit including only a pair of tracking coils 35, 36 can be obtained. Further, as shown in FIG. 4, the first magnetic circuit and the second magnetic circuit are arranged around objective lens 24 so as to cross each other. This arrangement provides the same function by using only half a number of coils as compared with conventional actuators, where four coils are disposed at each of four corners around the objective lens holder, and, thus, small sized and light weight apparatus can be obtained.

On account of such configurations, focus control and tilt control can be performed by applying electric currents through focus coils 33, 34 independently. Although, in the present preferred embodiment, focus coils are independently controlled, all of focus coils 33, 34 and tracking coils 35, 36 may be controlled independently. In this case eight suspension wires are required, but if one of the pair of coils, focus coils 33, 34, for example, are to be controlled independently, the number of suspension wires 39 can be reduced to six.

Focus magnets 41, 42 and tracking magnets 43, 44 are divided in the focusing direction and tracking direction, respectively, and poles N and S facing each other are bonded together. By adopting this configuration, the neutral zone occurring between poles can be suppressed and degradation of the magnetic circuit characteristic due to the shift of each coil can be minimized. In a control of high-density optical disk whose tilt margin is very narrow,

an accurate control can be performed by adopting above configuration of magnets bonded together to adjust the neutral zones.

Referring to FIG. 4 and FIGS. 9A, 9B again, magnetic yoke 45, together with focus magnets 41, 42 and tracking magnets 43, 44, constitute magnetic circuits. At this time, U-shaped branch yokes 45a, 45b branched from magnetic yoke 45 are extended upright between focus coil 33 and tracking coil 36, as well as between focus coil 34 and tracking coil 35. Then, magnetic fluxes constituting the focus magnetic circuit (first magnetic circuit) concentrate into branch yoke 45a and magnetic fluxes constituting the tracking magnetic circuit (second magnetic circuit) concentrate into branch yoke 45b.

More specifically, by the use of branch yokes 45a, 45b, the focus magnetic circuit (first magnetic circuit) and the tracking magnetic circuit (second magnetic circuit) can be set up independently of each other. Thus, the magnetic circuit and, as described above, current control through the coils for the focus control system and the tracking control system become independent of each other. Therefore, an accurate focus control and tracking control can be performed. In addition, focus magnets 41, 42 and tracking magnet 43 and 44 are provided with divided magnets to suppress neutral zones occurring between the poles, and the magnetic fluxes are arranged to be concentrated into branch yokes 45a, 45b. Therefore, a control with higher accuracy can be performed.

For reducing the size and decreasing occurrence of resonance in the focusing and tracking directions of suspension wires 39, the suspension wires 39 are given a tension and tapered to a somewhat V-shape (the actuator apparatus 12 side is widened, while the suspension holder 40 side 40 is narrowed as shown in FIG. 4). Magnetic yoke 45, from a magnetic point of view, serves as a magnetic yoke for focus magnets 41, 42 and for tracking magnets 43, 44. From a structural point of view, magnetic yoke 45, fixed to suspension holder 40 with an adhesive or the like, has a function to securely support suspension holder 40.

A part of suspension wires 39 pass through boxes 46 (boxy space, to be more precise) formed of magnetic yoke 45 and suspension holder 40, and boxes 46 are filled with a dumper gel for dumping. As the damper gel, such materials that become gel when irradiated by ultraviolet rays or the like are used.

A portion made up of objective lens holding cylinder 32, focus coils 33, 34, tracking coils 35, 36, substrates 37, 38, objective lens 24, and aperture filter 31 is, hereinafter, collectively called an actuator moving portion (“moving portion” of the present invention).

As shown in FIG. 2, laser driver 47 operates semiconductor laser incorporated in laser portion 13 to emit a wavelength of 780 nm and a wavelength of 635-650 nm lasers. It further has a function to apply high-frequency modulation to each of the wavelength lasers to reduce noise. Laser diver 47 is disposed beneath an underside of carriage 11 and held between the underside and a cover metal plate (not shown) disposed under carriage 11. Since the driver is in contact with carriage 11 and the cover metal plate, effective shielding and heat radiation can be achieved.

An optical structure of the optical pickup of the present preferred embodiment will be described.

Laser beam 15 of a wavelength of 780 nm emitted from laser portion 13 transmits through a diffraction grating for generating three beams, passes through prism 16 for splitting the beams, is collimated into parallel rays by collimator lens 20, deflected by beam splitter 21, reflected by mirror 23 and passes through aperture filter 31, and is condensed by objective lens 24 to be an optical spot on optical disk 1. Laser beam 15 reflected from optical disk 1 takes the reverse course to the above and is split by a wavelength selecting film in prism 16 and guided into the photodetector within photo detector device 14 by a diffraction grating disposed between prism 16 and photo detector device 14.

On the other hand, laser beam 15 of a wavelength of 635-650 nm emitted from laser portion 13 passes through the diffraction grating for generating three beams, passes through prism 16 for splitting the beams, is collimated into parallel rays by collimator lens 20, passes through beam splitter 21, is reflected by reflecting mirror 22, and beam-formed by beam forming prism 30. Then the beam passes through beam splitter 21 again, is reflected by mirror 23, passes through aperture filter 31, and is condensed by objective lens 24 to be formed into an optical spot on optical disk 1. Laser beam 15 reflected from the optical disk takes the opposite course and is guided by diffraction grating 17 to be introduced, through prism 16, into the photodetector within the photo detector device. This diffraction grating 17 is for splitting the beam of wavelength of 635-650 nm and is practically not affect laser beam 15 of a wavelength of 780 nm.

With reference to FIG. 4, FIG. 9A and FIG. 9B, the actuator moving portion of the present preferred embodiment will be described.

Power is supplied from a power source (not shown) to focus coils 33, 34, and tracking coils 35, 36, through the flexible circuit board attached to suspension holder 40, suspension wires 39 connected with the flexible circuit board, and substrates 37, 38. There are provided at least six suspension wires 39, two of which are connected to tracking coils 35, 36 connected in series, and, of the remaining four wires, two wires are connected to focus coil 33 and two wires are connected to focus coil 34. By a use of such connections, each of focus coils 33 and 34 can be controlled independently.

In FIG. 9A and FIG. 9B, by applying electric currents in positive direction (or negative direction) through each of focus coil 33 and focus coil 34, a focus magnetic circuit movable in the focusing direction, depending on relative positions of focus coils 33, 34 and focus magnets 41, 42 and relationship between the polarities of divided two magnetic poles, is formed. Control in the focusing direction can be performed according to the direction and amounts of the electric currents.

Next, by applying electric current through tracking coil 35 and tracking coil 36 in positive direction (or negative direction), a tracking magnetic circuit movable in the tracking direction, depending on relative positions of tracking coils 35, 36 and tracking magnets 43, 44 and relationship between the polarities of divided two magnetic poles, is formed, and thus a control in the tracking direction can be performed.

In the present preferred embodiment, as described above, electric currents are supplied to focus coil 33 and focus coil 34 independently. If, as shown in FIG. 10A and FIG. 10B, the direction of the current passed through one of the coils is reversed, a force to move focus coil 33 toward optical disk 1 is generated and a force to move focus coil 34 away from optical disk 1 is generated. As a result, by the opposite forces, a turning moment for turning the actuator moving portion in the radial direction is produced, thereby producing a tilt to reach a point at which the turning moment is balanced with a twisting moment acting on six suspension wires 39. By controlling the direction and amounts of the electric currents passed through focus coil 33 and focus coil 34, a tilt control in the radial direction can be performed.

Quite similarly, in a case where electric currents can be passed through tracking coil 35 and tracking coil 36 independently, if the direction of the current passed through one of the coils is reversed, a turning moment is produced on the actuator moving portion to turn it in a radial direction, and thus a tilt reaching a point at which the turning moment is balanced with a twisting moment acting on six suspension wires 39 is produced, whereby a tilt control in the radial direction becomes possible. Thus, the tilt control can be made by using both of focus coils 33, 34 and tracking coils 35, 36, or the tilt control is possible by using only one of the pairs of coils.

Self-cancel operation for canceling a tilt produced in the actuator portion by a lens shift will be described below. Referring again to FIGS. 6A-6C, there is shown the actuator apparatus of the first preferred embodiment of the invention in a state it is not yet made a lens shift in the tracking direction (in a neutral state). The oblique-lined regions of focus coils 33, 34 indicate the regions where magnetic fluxes in the focusing magnetic circuits for generating driving forces in the focusing direction exist. When no lens shift is made, the oblique-lined regions for generating forces of focus coil 33 and focus coil 34 in the focusing direction are equal to each other and, therefore, no tilt in the radial direction is produced when a focusing operation is performed in this state.

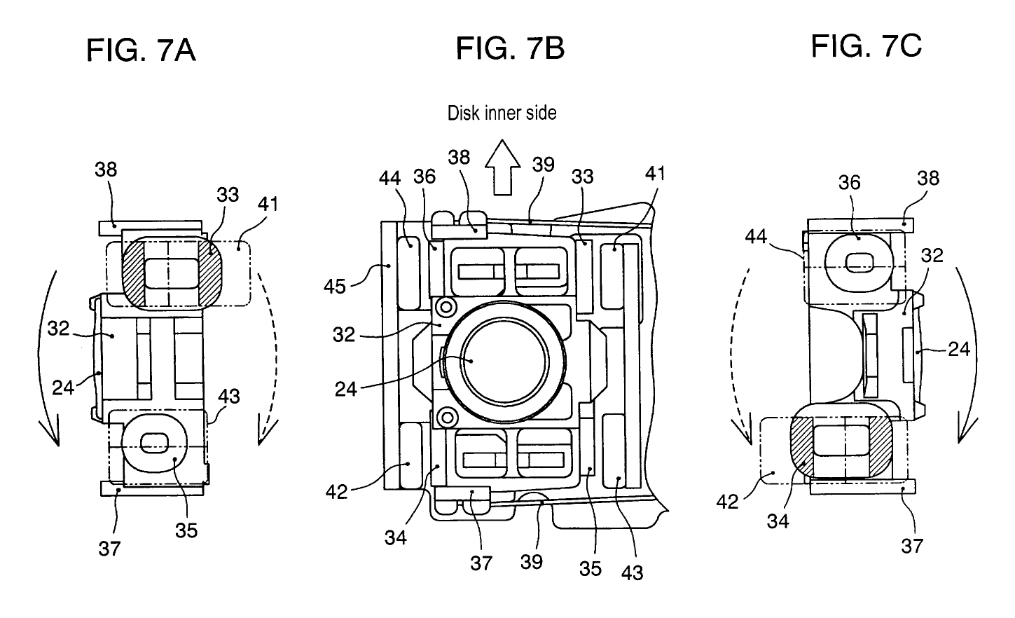

FIGS. 7A-7C show the actuator apparatus portion in a state when a lens shift toward the inner side occurs. FIG. 7A is a sectional view cut along a line W-W of FIG. 4 and seen from an arrow direction, FIG. 7B is a partially enlarged view, and FIG. 7C is a sectional view cut along a line Y-Y of FIG. 4 and seen from an arrow direction. The oblique-lined regions shown in FIG. 7A and FIG. 7C indicate the regions where magnetic fluxes of the focusing magnetic circuits generating driving forces in the focusing direction exist.

There is a problem with a conventional optical pickup actuator of a moving coil (hereinafter called MC) type that, when a focusing operation is performed while a lens shift is made in the tracking direction as shown in FIG. 7B, because the position of the magnet is unchanged, a focus driving point shifts in the direction opposite to the lens shift, and it is shifted from a center position of objective lens 24. When, in this state, objective lens 24 is moved to make a focusing operation, a radial tilt indicated by the broken-line arrows in FIG. 7A and FIG. 7C is produced in the case of the actuator of MC type.

In a case of the actuator of the present preferred embodiment, however, focus magnets 41, 42 are formed, as shown in FIG. 7A and FIG. 7C, to be smaller in width in the tracking direction than these of focus coils 33, 34. In addition, focus magnet 41 is fixed at a position shifted toward the disk inner side from focus coil 33 and focus coil 42 is fixed at a position shifted toward the disk periphery side from focus coil 34. Therefore, when a lens shift occurs toward the inner side as shown in FIG. 7B, the region of the focus coil 33 to generate a driving force in the focusing direction becomes wider than that of focus coil 34. Therefore, when objective lens 24 is moved to make a focusing operation, a radial tilt is generated in the direction as indicated by the solid-line arrow in FIGS. 7A and 7C, whereby the radial tilt indicated by the broken-line arrow is cancelled. Likewise, when a focusing operation is made in the opposite direction, radial tilt in the opposite direction is generated and the generated tilt is cancelled. Incidentally, the widths of focus magnets 41, 42 in the tracking direction, the setting of the above described regions, and the fixed positions of the focus magnets are adjusted so that the radial tilt and the moment may balance with each other.

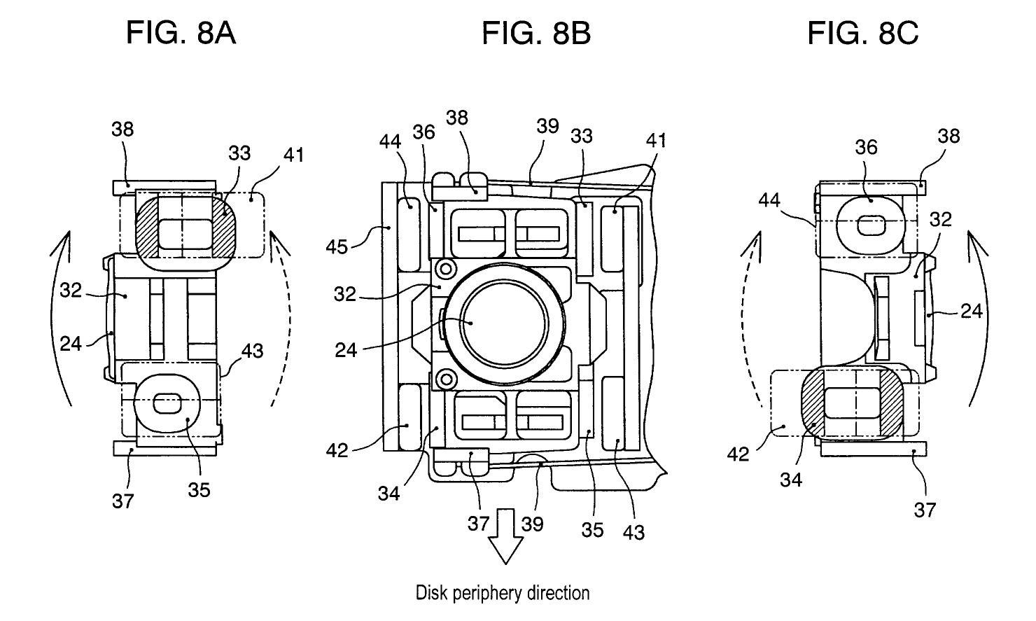

FIGS. 8A-8C show the actuator apparatus portion in a state where an opposite lens shift (toward the periphery side) occur. FIG. 8A is a sectional view cut by the line W-W of FIG. 4 and seen from the direction of the arrow, FIG. 8B is a partially enlarged view, and FIG. 8C is a sectional view cut by the line W-W of FIG. 4 and seen from the direction of the arrow. The oblique-lined regions shown in FIG. 8A and FIG. 8C indicate the regions where magnetic fluxes of the focusing magnetic circuits generating driving forces in the focusing direction exist. When, a focusing operation is performed while the MC-type actuator shifts toward the disk periphery side as shown in FIG. 8B, the focus driving point is shifted in the direction opposite to the lens shift because the positions of the magnets are unchanged, and thus the center position of objective lens 24 shifts. When, in this state, objective lens 24 is caused to make a focusing operation, a radial tilt indicated by the broken-line arrows is produced in the case of the conventional MC type actuator of.

In the case of the actuator of the present preferred embodiment, however, focus magnets 41, 42 are formed to be smaller in width in the tracking direction than these of focus coils 33, 34. In addition, as to the fixed positions of the focus magnets, focus magnet 41 is shifted toward the disk inner side from focus coil 33 and focus coil 42 is shifted toward the disk periphery side from focus coil 34. Therefore, when a lens shift is made toward the periphery side as shown in FIG. 8B, the region of the focus coil 34 in which a driving force in the focusing direction is generated becomes wider than that of focus coil 33. Therefore, when objective lens 24 performs a focusing operation, a radial tilt is generated in the direction as indicated by the solid-line arrow, whereby the radial tilt indicated by the broken-line arrow is cancelled. Likewise, when a focusing operation is made in the opposite direction, radial tilt in the opposite direction is generated and the generated tilt is cancelled. Incidentally, the widths of focus magnets 41, 42 in the tracking direction, the setting of the above described regions, and the fixed positions of the focus magnets are adjusted so that the radial tilt and the moment may balance with each other.

As described above, according to the actuator apparatus of the present invention, when a forced shift is made by moving objective lens 24 to make a tracking shift (collectively called a lens shift in a broad sense), the tilt occurring at the actuator portion can be self-cancelled. Therefore, accuracy in each of the focus, the tracking, and the tilt control, which are originally aimed controls of the present invention, can be enhanced. Further, according to the optical pickup employing the actuator apparatus of the present invention, by a use of the enhanced controlling accuracy, accurate and highly reliable reproducing or recording operation can be made. Thus, according to the optical pickup employing the actuator apparatus of the present invention and the optical disk apparatus using the same can perform accurate and highly reliable reproducing or recording operation.

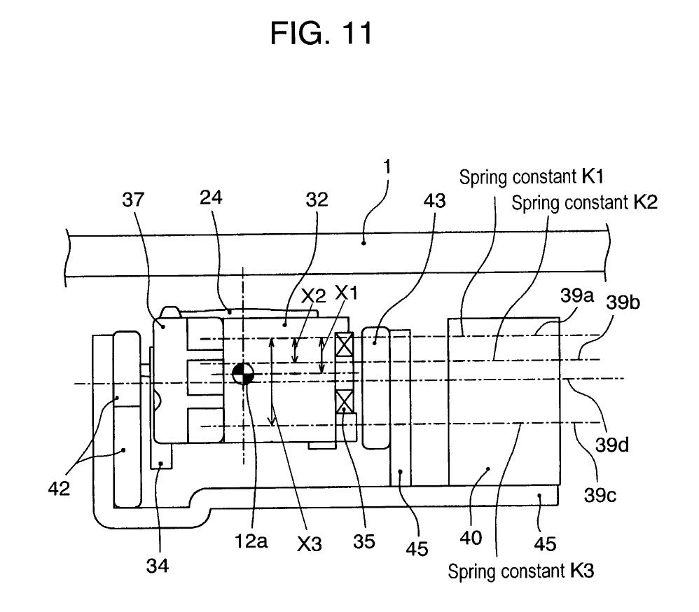

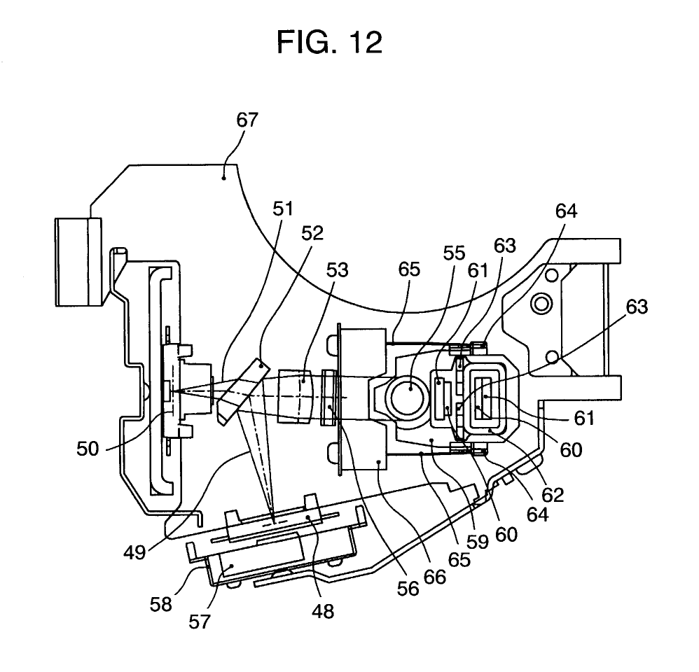

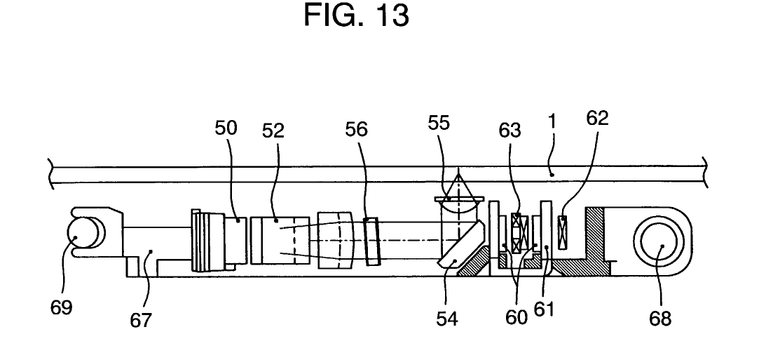

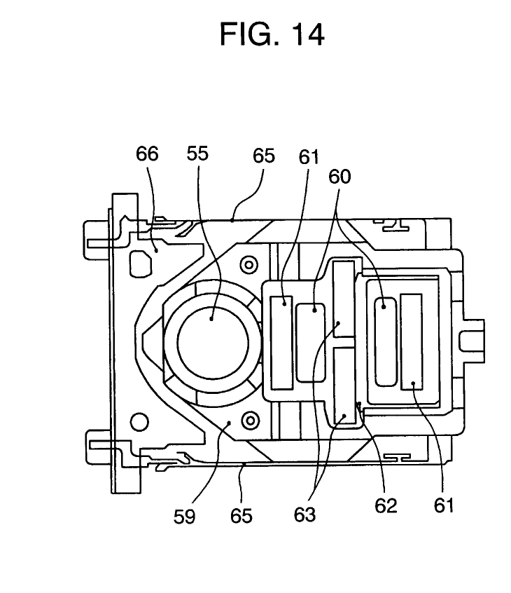

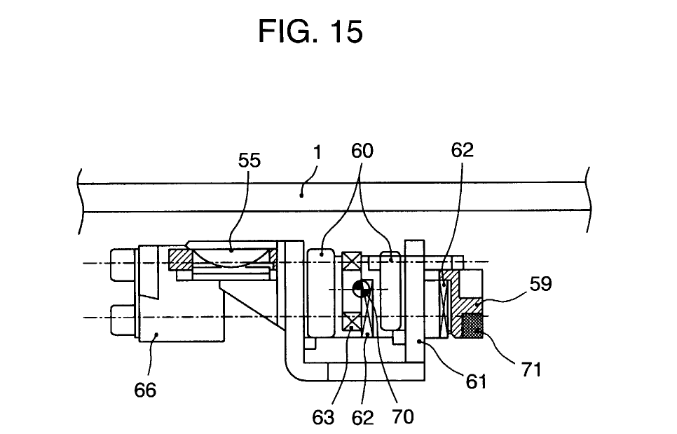

In the meantime, forces of gravity, other than the controlling operations described above, are applied to members of the actuator and a rotation due to the gravity is produced around the center of gravity of the moving portion. This will be described in detail with reference to FIG. 11. FIG. 11 is a sectional view taken along the line Z-Z of FIG. 4.

Three pairs of suspension wires 39a, 39b, and 39c, each pair being located sandwiching objective lens 24 are disposed, where spring constant of each wires are K1, K2, and K3, respectively. Using the position (height) of wire 39a taken along the focusing direction as a reference, wire 39a is defined to be located at a distance of X1 from the position of center of gravity 12a of the actuator moving portion, while wire 39b is defined to be at a distance of X2 from wire 39a and wire 39c is defined to be at a distance of X3 from wire 39a. Line 39d is a center line between wire 39a and wire 39c.

In the present preferred embodiment, a center of driving forces of tracking coils 35 and 36 is set in agreement with center of gravity 12a of an actuator moving portion.

As the moment in the plane in the radial direction, there is a moment due to the driving forces of tracking coils 35, 36. Driving forces of tracking coils 35, 36 are applied to objective lens holding cylinder 32 and supported as component forces by wires 39a, 39b, and 39c. Therefore, it is desirable that a proper balance is obtained among moments around the center of gravity due to the component forces.

Since elongations of wires 39a, 39b, 39c are equal, the conditional equation to obtain the balance of the moments around center of gravity 12a is given as:

X1·K1+(X1−X2)·K2=(X3−X1)·K3

Since distances X1, X2, and X3 of wires 39a, 39b, and 39c are decided in the designing stage, a first method to satisfy the above condition is to select the spring constants K1, K2, and K3 to satisfy:

X1·K1+(X1−X2)·K2=(X3−X1)·K3

This method is an effective way when distances X1, X2, and X3 are designed to be small for miniaturization of the actuator.

A second method to satisfy the above condition, when the spring constants K1, K2, and K3 of wires 39a, 39b, and 39c are preliminary decided by the materials during the deign and the like, is to design the distances X1, X2, and X3 to satisfy:

X1·K1+(X1−X2)·K2=(X3−X1)·K3.

Even when this method is used, the moments around center of gravity 12a can be cancelled. This method simply realizes the cancellation of the moments when materials for wires 39a, 39b, and 39c are decided.

According to the present invention, as described above, the first magnetic circuits and the second magnetic circuits are disposed around objective lens 24 so as to cross each other. By a use of this arrangement, the number of coils disposed can be reduced to one half of these of the conventional one and a small sized and light weight apparatus can be provided.

Further, the first focus magnetic circuit and the second focus magnetic circuit are symmetrically arranged about the center of the objective lens and, in addition, the first tracking magnetic circuit and the second tracking magnetic circuit are symmetrically arranged about the center of the objective lens, the center of the electromagnetic driving forces can be coincided with the center of objective lens 24. Therefore, accurate focus control and tracking control can be obtained.

Further, three-axis actuator capable of radial tilt control and usable for high-density optical disks whose tilt margin is very narrow can be obtained. Since the moving portion can save weight, a highly sensitive optical pickup actuator can be produced and an optical pickup actuator consuming low energy can be provided. Further, by employment of divided magnets bonded together, instead of multipole magnetization, neutral zones produced between the magnetic poles can be suppressed and degradation of magnetic circuit characteristic due to shift of each coil can be suppressed. Thus, an actuator with high linearity can be provide d.

Further, by a use of proper arrangement of coils and magnets, a radial tilt caused by a lens shift can be self-cancelled. Thus, the tilt occurring in the actuator portion caused by a lens shift can be self-cancelled. Therefore, accuracy in each of focus, tracking, and tilt control, originally aimed controls of the present invention, can be enhanced.

Especially, according to the present invention, since suspension wires 39a, 39b, and 39c and distances X1, X2, and X3 are set to satisfy:

X1·K1+(X1−X2)·K2=(X3−X1)·K3,

moments around the center of gravity of the moving portion can be cancelled at any time and hence unwanted tilts are not created. Therefore, mass balances and the like which have been required can be eliminated and, hence, a weight of the moving portion of the optical pickup actuator can be decreased.

According to the optical pickup employing the actuator apparatus of the present invention, controlling accuracy can be enhanced and, thereby, accurate and highly reliable reproduction or recording operation can be perfumed. Further, according to the optical pickup employing the small-sized and low-weighed actuator apparatus, a small-sized, low-power consuming, and yet accurate and highly reliable optical pickup can be obtained.

Thus, according to the optical pickup employing the actuator apparatus of the present invention and the optical disk apparatus using the same, accurate and highly reliable reproducing or recording operation can be performed. Further, a thin and small, and yet low-power consuming and highly reliable optical disk apparatus, that can even be mounted on a mobile PC, is provided.

What is claimed is:

1. An optical pickup actuator comprising:
a moving portion comprising:
an objective lens;
an objective lens holding cylinder for holding said objective lens;
a focus coil, and
a tracking coil;
a first magnetic circuit comprising a focus magnet for driving said focus coil and a magnetic yoke;
a second magnetic circuit comprising a tracking magnet for driving said tracking coil and a magnetic yoke; and
an elastic member for supporting said moving portion, wherein
said first magnetic circuit has a pair of said focus coils and a pair of said focus magnets substantially symmetrically about said objective lens and said second magnetic circuit has a pair of said tracking coils and a pair of said tracking magnets disposed substantially symmetrically about said objective lens.

2. The optical pickup actuator according to claim 1, wherein each of said pair of focus magnets and said pair of tracking magnets comprises a plurality of divided magnets joined together.

3. The optical pickup actuator according to claim 1, wherein said pair of focus magnets are divided such that opposite magnetic poles appear in a focusing direction, said pair of tracking magnets are divided such that opposite magnetic poles appear in a tracking direction, and each of said magnets is formed by joining opposite magnetic poles in contact with each other.

4. The optical pickup actuator according to claim 1, wherein a width of said focus magnet in a tracking direction is smaller than a width of said focus coil in the tracking direction.

5. The optical pickup actuator according to claim 1, wherein a center of width of said focus magnet in a tracking direction is shifted from a center of a width of said focus coil in the tracking direction.

6. The optical pickup actuator according to claim 1, wherein an electric power is supplied to each of said pair of focus coils independently.

7. The optical pickup actuator according to claim 1, wherein an electric power is supplied to each of said pair of tracking coils independently.

8. The optical pickup actuator according to claim 6, wherein said electric power is supplied by means of at least six elastic members supporting said moving portion.

9. The optical pickup actuator according to claim 7, wherein said electric power is supplied by means of at least six elastic members supporting said moving portion.

10. The optical pickup actuator according to claim 1, wherein said focus coil has a ring-shaped winding.

11. The optical pickup actuator according to claim 1, wherein said tracking coil has a ring-shaped winding.

12. The optical pickup actuator according to claim 3, wherein a polarity of said focus magnet facing to one side of bundle of said focus coil is opposite to a polarity of said focus magnet facing to another side of bundle of said focus coil.

13. The optical pickup actuator according to claim 3, wherein a polarity of said tracking magnet facing to one side of bundle of said tracking coil is opposite to a polarity of said tracking magnet facing to another side of bundle of said tracking coil.

14. The optical pickup actuator according to claim 1, wherein a plurality of pairs of said elastic members are disposed in a focusing direction, each pair of said elastic members sandwiching said objective lens, and each pair of said elastic members have different spring constants with other pairs of said elastic members.

15. The optical pickup actuator according to claim 1, wherein said elastic member comprises three pairs of elastic members, and following conditions are satisfied.
X1·K1+(X1−X2)·K2=(X3−X1)·K3
where K1, K2, and K3 are spring constants of each of the pairs of elastic members in the order from the pair closest to the optical disk, and
X1 is a distance from an elastic member having an spring constant of K1 to a center of gravity of said moving portion, said distance being taken along a focusing direction from a position of said elastic member having spring constant of K1 (reference position),
X2 is a distance from the reference position to an elastic member having an spring constant of X2, and
X3 is a distance from the reference position to an elastic member having an spring constant of X3.

16. An optical disk apparatus using the optical pickup actuator as described in claim 1.

17. An optical pickup actuator comprising:
a moving portion comprising:
an objective lens;
an objective lens holding cylinder for holding said objective lens;
a pair of focus coils; and
a pair of tracking coils;
a first magnetic circuit comprising a pair of focus magnets for driving said pair of focus coils and a magnetic yoke, said pair of focus coils and said pair of focus magnets being disposed symmetrically about a center of said objective lens;
a second magnetic circuit comprising a pair of tracking magnets for driving said pair of tracking coils and said magnetic yoke, said pair of tracking coils and said pair of tracking magnets being disposed symmetrically about the center of said objective lens; and
a plurality of conducting elastic members supporting said moving portion.

18. The optical pickup actuator according to claim 17, wherein each of said pair of focus magnets is divided such that opposite magnetic poles appear in a focusing direction, each of said pair of tracking magnets are divided such that opposite magnetic poles appear in a tracking direction, and both of said divided magnets are formed by placing opposite magnetic poles in contact with each other.

19. The optical pickup actuator according to claim 17, wherein a width of each of said focus magnet in a tracking direction is smaller than a width in the tracking direction of a focus coil facing to said focus magnet, and a center of the width of said focus magnet is shifted from a center of the width of said focus coil.

20. The optical pickup actuator according to claim 17, wherein said actuator has at least six elastic members and each of said pair of focus coils are supplied with electric power independently.

21. The optical pickup actuator according to claim 17, wherein said actuator has at least six elastic members and each of said pair of tracking coils are supplied with electric power independently.

22. The optical pickup actuator according to claim 17, wherein said focus coil is wound in a ring shape and a surface plane of said focus coil facing to said focus magnet is parallel to a focusing direction.

23. The optical pickup actuator according to claim 17, wherein said tracking coil is wound in a ring shape and a surface plane of said tracking coil facing to said tracking magnet is parallel to a focusing direction.

24. The optical pickup actuator according to claim 17, wherein a surface plane of said focus coil is parallel to a focusing direction and said surface plane of said focus coil faces to said focus magnet, said focus magnet being formed of divided magnet such that opposite magnetic poles appear in the focusing direction, and said divided magnets being formed by placing opposite magnetic poles in contact with each other.

25. The optical pickup actuator according to claim 24, wherein a polarity of said focus magnet facing to one side of a bundle of said focus coil is opposite to a polarity of said focus magnet facing to another side of a bundle of said focus coil.

26. The optical pickup actuator according to claim 17, wherein a surface plane of said tracking coil is parallel to a focusing direction and said surface plane of said tracking coil faces to said tracking magnet, said tracking magnet being formed of divided magnet such that opposite magnetic poles appear in the focusing direction, and said divided magnet being formed by placing opposite magnetic poles in contact with each other.

27. The optical pickup actuator according to claim 24, wherein a polarity of said tracking magnet facing to one side of a bundle of said tracking coil is opposite to a polarity of said tracking magnet facing to another side of a bundle of said tracking coil.

28. The optical pickup actuator according to claim 17, wherein a plurality of pairs of said elastic members are disposed in a focusing direction, each of said pair of said elastic members sandwiching said objective lens, and each of said pair of said elastic members having different spring constant with other pairs of said elastic members.

29. The optical pickup actuator according to claim 17, wherein said elastic member is formed of three pairs of elastic members, and following condition is satisfied.
X1·K1+(X1−X2)·K2=(X3−X1)·K3.
where K1, K2, and K3 are spring constants of each of the pairs of elastic members in a order from a pair closest to the optical disk,
where K1, K2, and K3 are spring constants of each of the pairs of elastic members in the order from the pair closest to the optical disk, and
X1 is a distance from an elastic member having an spring constant of K1 to a center of gravity of said moving portion, said distance being taken along a focusing direction from a position of said elastic member having spring constant of K1 (reference position),
X2 is a distance from the reference position to an elastic member having an spring constant of X2, and
X3 is a distance from the reference position to an elastic member having an spring constant of X3.

30. An optical disk apparatus employing the optical pickup actuator as described in claim 17.

31. An optical pickup actuator comprising:
a moving portion comprising:
an objective lens;
an objective lens holding cylinder for holding said objective lens;
a pair of focus coils; and
a pair of tracking coils;
a first magnetic circuit comprising a pair of focus magnets for driving said pair of focus coils and a magnetic yoke, said pair of focus coils and said pair of focus magnets being disposed symmetrically about a center of said objective lens;
a second magnetic circuit comprising a pair of tracking magnets for driving said pair of tracking coils and said magnetic yoke, said pair of tracking coils and said pair of tracking magnets being disposed symmetrically about the center of said objective lens; and
a plurality of conducting elastic members supporting said moving portion,
wherein said first magnetic circuit and said second magnetic circuit are disposed around said objective lens so as to cross with each other.

32. The optical pickup actuator according to claim 31, wherein each of said pair of focus magnets is divided such that opposite magnetic poles appear in a focusing direction, each of said pair of tracking magnets are divided such that opposite magnetic poles appear in a tracking direction, and both of said divided magnets are formed by placing opposite magnetic poles in contact with each other.

33. The optical pickup actuator according to claim 31, wherein a width of each of said focus magnet in a tracking direction is smaller than a width in the tracking direction of a focus coil facing to said focus magnet, and a center of the width of said focus magnet is shifted from a center of the width of said focus coil.

34. The optical pickup actuator according to claim 31, wherein
said magnetic yoke has a branch yoke projecting upright between said focus coil and said tracking coil, whereby said first magnetic circuit and said second magnetic circuit are set to be independent of each other.

35. The optical pickup actuator according to claim 31, wherein said actuator has at least six elastic members and each of said pair of focus coils are supplied with electric power independently.

36. The optical pickup actuator according to claim 31, wherein said actuator has at least six elastic members and each of said pair of tracking coils are supplied with electric power independently.

37. The optical pickup actuator according to claim 31, wherein said focus coil is wound in a ring shape, a surface plane of a winding of said focus coil is parallel to a focusing direction, an axis of the winding is orthogonal to the focusing direction, and said surface plane of the winding is facing to said focus magnet, said focus magnet being formed of a divided magnet in which opposite magnetic poles appear in a focusing direction, and said divided magnet being made by placing opposite magnetic poles in contact with each other.

38. The optical pickup actuator according to claim 37, wherein a polarity of said focus magnet facing to one side of a bundle of said focus coil is opposite to a polarity of said focus magnet facing to another side of a bundle of said focus coil.

39. The optical pickup actuator according to claim 31, wherein said tracking coil is wound in a ring shape, a surface plane of a winding of said tracking coil is parallel to a focusing direction, an axis of the winding is orthogonal to the focusing direction, and said surface plane of winding is facing to said tracking magnet, said tracking magnet being a divided magnet such that opposite magnetic poles appear in a tracking direction, and said divided magnet being made by placing opposite magnetic poles in contact with each other.

40. The optical pickup actuator according to claim 39, wherein a polarity of said tracking magnet facing to one side of a bundle of said tracking coil is opposite to a polarity of said tracking magnet facing to another side of a bundle of said tracking coil.

41. The optical pickup actuator according to claim 39, wherein a plurality of pairs of said elastic members are disposed in a focusing direction, each of said pair of said elastic members sandwiching said objective lens, and each of said pair of said elastic members having different spring constant with other pairs of said elastic members.

42. The optical pickup actuator according to claim 31, wherein said elastic member is formed of three pairs of elastic members, and following condition is satisfied.
X1·K1+(X1−X2)·K2=(X3−X1)·K3.
where K1, K2, and K3 are spring constants of each of the pairs of elastic members in a order from a pair closest to the optical disk,
where K1, K2, and K3 are spring constants of each of the pairs of elastic members in the order from the pair closest to the optical disk, and
X1 is a distance from an elastic member having an spring constant of K1 to a center of gravity of said moving portion, said distance being taken along a focusing direction from a position of said elastic member having spring constant of K1 (reference position),
X2 is a distance from the reference position to an elastic member having an spring constant of X2, and
X3 is a distance from the reference position to an elastic member having an spring constant of X3.

43. An optical disk apparatus using the optical pickup actuator as described in claim 31.
